(19) United States
(12) Patent Application Publication
(10) Pub. No.: US 2003/0101545 A1
(43) Pub. Date: Jun. 5, 2003

(54) Paper clip

(76) Inventor: Ray-Ling Hsiao, Taipei (TW)

Correspondence Address: DOUGHERTY & TROXELL, SUITE 1404, 5205 LEESBURG PIKE, FALLS CHURCH, VA, 22041, US

(21) Appl. No.: 10/002,204

(22) Filed: Dec. 5, 2001

(51) Int. Cl. B42F 1/02

(52) U.S. Cl. 24/67.9

(57) ABSTRACT

The present invention is an improved paper clip, which is applied on different thicknesses of documents, even only one single paper. The improved paper clip includes three elements, which are a first clipping piece, a second clipping piece and a support beam. The first clipping piece is with a sunken slot; the second clipping piece consists of a bending curve part and a horizontal part, a bottom curve surface of the bending curve part protrudes into the sunken slot and is roughened to become a rough surface for increasing friction to tightly clamp documents or one paper; the support beam, first clamping piece and second clamping piece form a capacity to store thicker documents.

### FIELD OF THE INVENTION

The present invention is an improved paper clip; especially it is for clamping different thicknesses of documents.

### BACKGROUND OF THE INVENTION

Traditionally, most kinds of paper clips are made of steel wires. It is very convenient for clipping documents and especially for papers. Referring to FIG. 1, which is the 3-dimension view of prior art and normally made of plastic, because plastic is a flexible material. A bottom surface of paper 4 is put on first clipping piece 1, and second clipping piece 2 is above a top surface of paper 4, which means paper 4 is within the first clipping piece 1 and the second clipping paper 2; Top edge 401 is against to joint place 3, thus the paper 4 can be clamped tightly. The first clipping piece 1 and the second clipping piece 2 are located at the same horizontal plane, which means joint place 3 is no height difference. Therefore, this type of paper clip as in FIG. 1 is just suitable for thin thickness of document, such as one paper or only a couple of papers; on the other hand, a thick document is not tightly clamped.

Referring to FIG. 2, which is another 3-dimension view of prior art. This is an advance type of clip. First clipping piece 5 and second clipping piece 6 are not on the same horizontal plane, and support beam 7 is with a height, therefore the height has a capacity for thicker documents, but the prior art cannot be tightly enough to clamp one piece of paper, because touching line 8 of the first clipping piece 5 and the second clipping piece 6 is formed as a line, thus the clamping force is not strong enough.

Referring to FIG. 3, which is the third 3-dimension view of prior art and the oldest but the most convenient prior art, so the shortcomings of the types in FIGS. 1 and 2 are all included in the prior art. Which means that first clipping piece 9 and second clipping piece 10 are at the same horizontal plane, so the prior art is not suitable for thicker documents as well; further, the prior art is made of steel wire as usual, thus the application force for clamping is as two individual lines, so the application condition is just same as the prior art in FIG. 2. Therefore, the prior arts as mentioned above are not good enough to manage the present paper work operations.

### BRIEF DESCRIPTION OF THE INVENTION

The first object of the present invention is to offer an improved paper clip to have a function for clamping thicker documents. The present invention supplies a capacity for storing thicker documents, and also the thickness of the capacity is variable, thus the present invention can be widely applied on paper work.

The second object of the present invention is to offer an improved paper clip to have a function for enough clamping force to even one piece of paper.

For your esteemed review committee members to further understand and recognize the object, the characteristic and the function of the present invention, a detailed description with corresponding diagrams are presented as following:

### BRIEF DESCRIPTION OF THE DRAWINGS

FIG. 1 is the 3-dimension view of prior art.

FIG. 2 is another 3-dimension view of prior art.

FIG. 3 is the third 3-dimension view of prior art.

FIG. 4 is the 3-dimension view of the preferred embodiment of the present invention.

FIG. 5 is the side view of the preferred embodiment of the present invention.

FIG. 6 is the sectional view of another preferred embodiment of the present invention.

FIG. 7 is the top view of the embodiment in FIG. 6.

FIG. 8 is the 3-dimension view of the embodiment in FIG. 6.

FIG. 9 is the top view of the preferred logo embodiment of the present invention.

FIG. 10 is the top view of another preferred logo embodiment of the present invention.

FIG. 11 is the 3-dimension view of another embodiment.

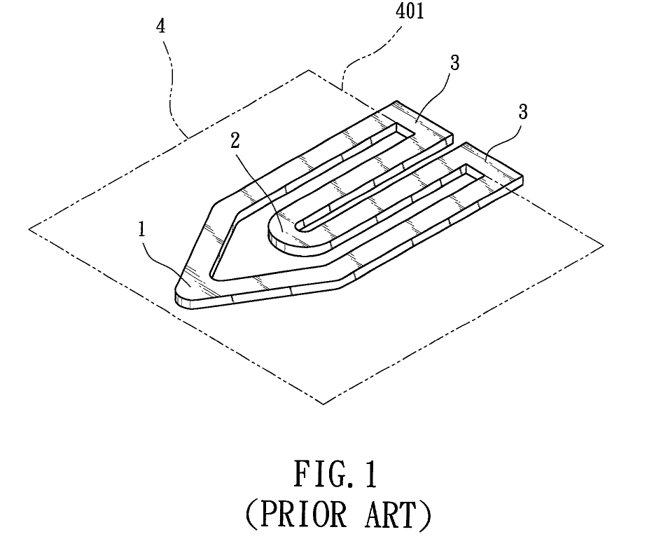

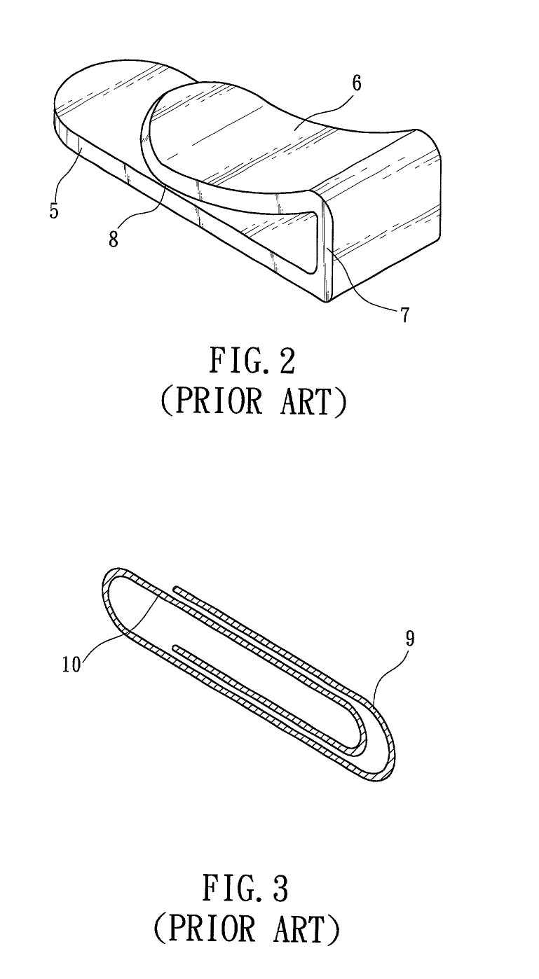

### DETAILED DESCRIPTION OF THE PREFERRED EMBODIMENT

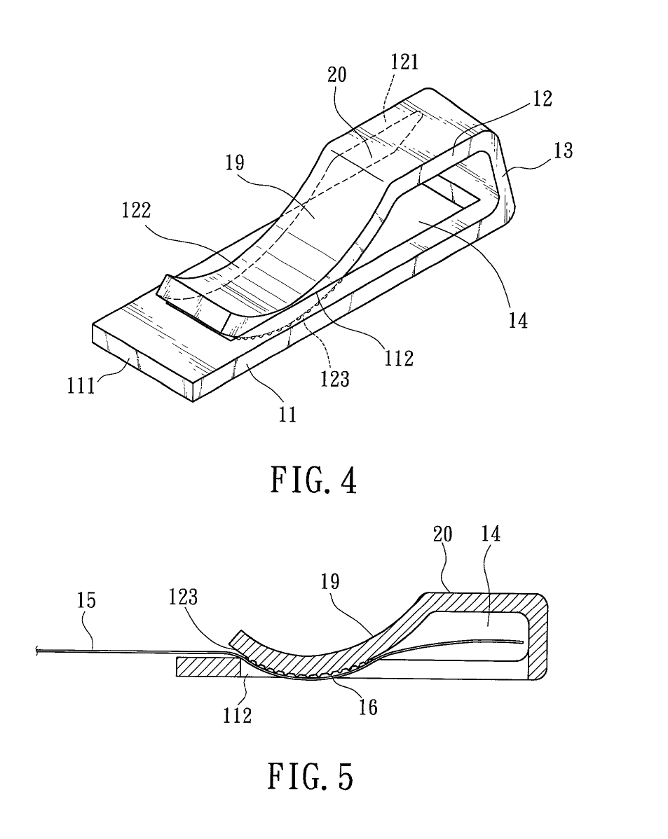

Referring to FIG. 4, which is the 3-dimension view of the preferred embodiment of the present invention. The improved paper clip is made of plastic or steel. A first clipping piece 11 with thin plane shape for placing document is almost parallel to a top surface 121 of a horizontal part 20 of a second clipping piece 12, and which is a lower part of the paper clip preferred embodiment; the second clipping piece 12 with thin plane shape is an upper part of the preferred embodiment. The first clipping piece 11 is larger than the second clipping piece 12. A connected end by a support beam 13 on first clipping piece 11 is located on an opposite side to a side with a sunken slot 112, where document inserted in, a connected end by the support beam 13 on second clipping piece 12 is the same side as the connected end on first clipping piece 11, support beam 13 is placed within first clipping piece 11 and second clipping piece 12 in vertical direction. Support beam 13 with a certain height is almost vertical to both first clipping piece 11 and the top surface 121 and individually connects to one end of each clipping piece, also, the support beam with certain height is available for different thickness of documents. An outer surface of the support beam may be a curve surface or a plain. Another section of second clipping piece 12 is formed a bending curve part 19 with downward, and the curve forms a top curve surface 122 and a bottom curve surface 123. The bottom curve surface 123 protrudes down into the sunken slot 112 of first clipping piece 11. The sunken slot 112 is a hollow type. Obviously, there is a capacity 14 among a horizontal section of second clipping piece 12, support beam 13 and first clipping piece 11, which is for storing thicker documents.

Referring to FIG. 5, which is the side view of the preferred embodiment of the present invention. The bottom surface 123 is roughened to become a roughened surface 16. As showing in the figure, a paper 15 is clamped in sunken slot 112, and because of the roughened surface 16, the paper 15 is tightly fixed and clamped there. In another words, the paper clip is suitable for even one single paper.

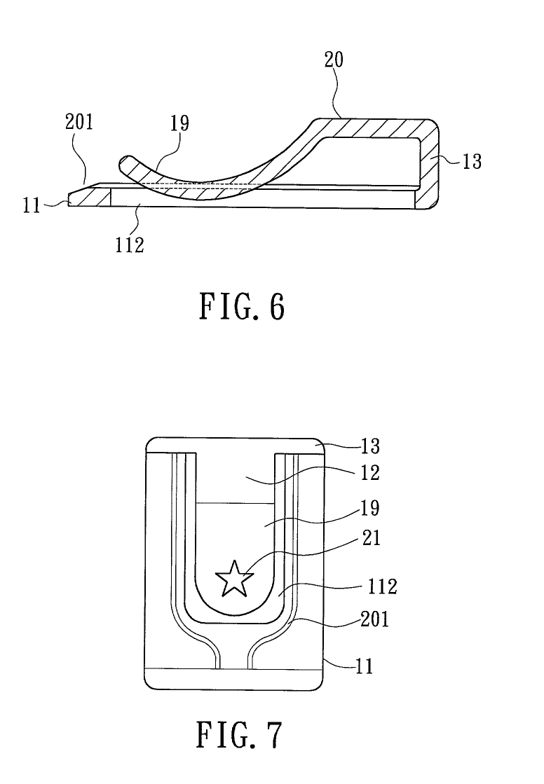

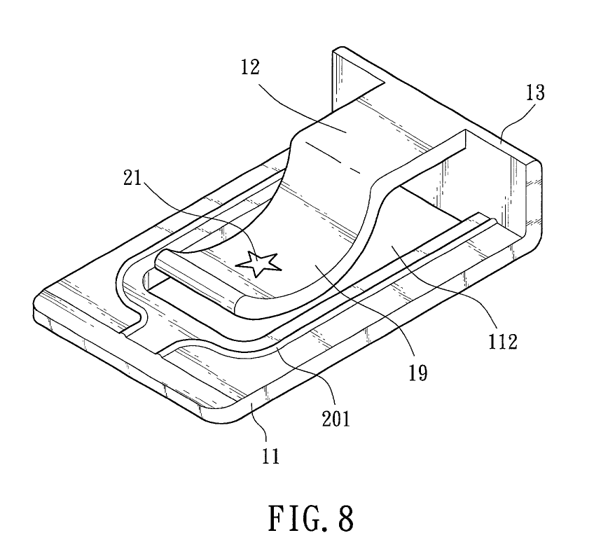

Referring to FIG. 6, which is the sectional view of another preferred embodiment of the present invention, and the embodiment is sort of improvement comparing to the embodiment in both FIGS. 4 and 5. The sunken slot 112 is a hollow type, and more clamping force can be put on. Two ridges 201 are set on the first clipping piece 11 for enhancing the hardness of the first clipping piece 11. Referring to FIG. 7, which is the top view of the embodiment in FIG. 6. As showing in the figure, the second clipping piece 12 is a little smaller than the sunken slot 112. Two ridges 201 are symmetrically distributed on the first clipping piece 11 to enhance the hardness of the first clipping piece 11. Further, a star logo can be engraved on top of the curve part 19.

Referring to FIG. 8, which is the 3-dimension view of the embodiment in FIG. 6. It could be clearly shown for the second preferred embodiment. Wherein, the first clipping piece 11, the support beam 13 and the second clipping piece 12 are formed in one module. The support beam 13 is as wide as the first clipping piece 11 to enhance a structure of the support beam 13. The second clipping piece 12 man directly extend from the support beam 13 into the sunken slot 112.

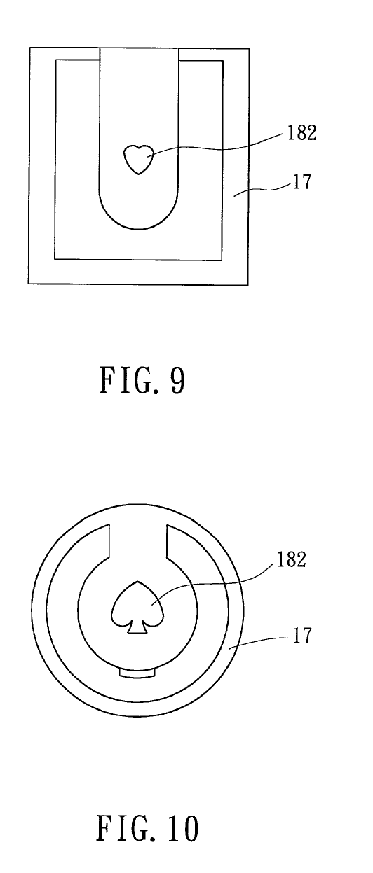

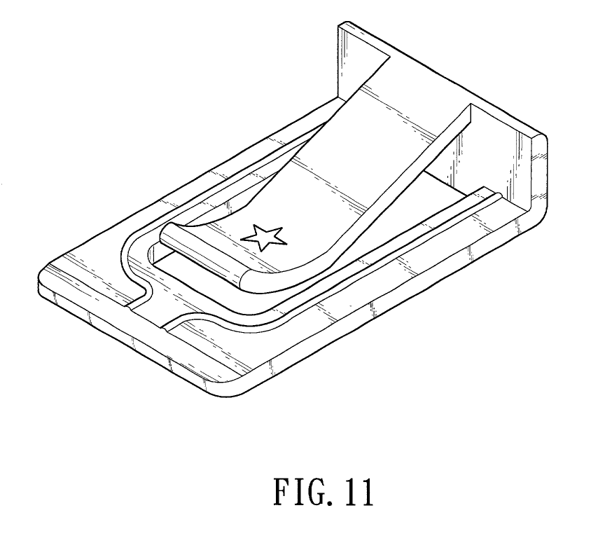

Referring to FIG. 9, which is the top view of the preferred logo embodiment of the present invention. A logo can be put on a top curve surface 182, and not on a first clipping piece 17. Therefore, the logo represents a company, group or personal sign, which is a sort of advertisement. The design is suitable for commercial use, memorial, gift, etc. FIG. 10 is the top view of another preferred logo embodiment of the present invention, which means a logo could be put in many types for different situations.

Referring to FIG. 11, which is the 3-dimension view of another embodiment. A difference with the embodiment in FIG. 8 is that the second clipping piece 12 is without the curve part 19, and the second clipping piece 12 directly extends from the support beam 13 into the sunken slot 112.

As a conclusion of the aforesaid embodiments, the present invention can be widely applied on different thicknesses of documents and fields for representing their signs. Further, the above descriptions are the preferable embodiments of the present invention. The covered scopes of the present invention are not restricted on the embodiments shown in the present invention. All the changes according to the contents of the present invention, such as: the change of shapes or locations of the arrangement of the fastening structures, etc., the generated functions and characteristics similar to those of the embodiments of the present invention and any ideas thought by the persons well-known such technologies are all within the scopes of the present invention.

What is claimed is:

1. An improved paper clip, which is applied on clamping documents, and consists of:
a first clipping piece having a thin plane shape with a sunken part for placing documents and a lower part of the paper clip, the sunken part being as a hollow type;
a second clipping piece having a thin plane shape with at least a bending curve of the second clipping piece and an upper part of the paper clip, the bending curve part being protruded downward to the sunken part of the first clipping piece; the second clipping piece being almost parallel to the first clipping piece, and the second clipping piece being smaller than the sunken part of the first clipping piece;
a support part having a certain height and individually connecting to one end of each clipping piece, a connected end by the support part on first clipping piece being located on an opposite side to a side where document inserted in, a connected end by the support part on second clipping piece being the same side as the connected end on first clipping piece, support part being placed within first clipping piece and second clipping piece in vertical direction.

2. The improved paper clip as cited in claim 1, wherein, the paper clip is made of plastic.

3. The improved paper clip as cited in claim 1, wherein, the paper clip is made of steel.

4. The improved paper clip as cited in claim 1, wherein, there is at least one ridge set on the first clipping piece for enhancing the hardness of the first clipping piece.

5. The improved paper clip as cited in claim 1, wherein, a bottom surface of the bending curve part of the second clipping piece, protruding down into the sunken part of the first clipping piece, is roughened.

6. The improved paper clip as cited in claim 1, wherein, the certain height of support part is available for different thicknesses of documents.

7. The improved paper clip as cited in claim 1, wherein, the bending curve part protrudes down into the sunken part of the first clipping piece, thus only one paper can be clamped tightly.

8. The improved paper clip as cited in claim 1, wherein, the second clipping piece is able to put at least one logo.

9. The improved paper clip as cited in claim 1, wherein, the second clipping piece may directly extend from the support beam into the sunken part.
